(19) United States
(12) Patent Application Publication
(10) Pub. No.: US 2009/0291773 A1
(43) Pub. Date: Nov. 26, 2009

(54) PRECISION GROUND PUTTER FACE

(76) Inventors: Richard De La Cruz, Carlsbad, CA (US); Richard D. De La Cruz, Encinitas, CA (US)

Correspondence Address: STEVEN W. WEBB, 825 College Blvd., Suite 102620, Oceanside, CA, 92057, US

(21) Appl. No.: 12/407,800

(22) Filed: Mar. 20, 2009

Related U.S. Application Data
(60) Provisional application No. 61/056,041, filed on May 26, 2008.

(51) Int. Cl. A63B 53/04; B23P 13/02

(52) U.S. Cl. 473/331; 473/340; 29/557

(57) ABSTRACT

A new method for producing a precision-ground golf club face is presented, the golf club face possessing a hitting zone comprised of several parallel grooves ground into the surface. The hitting zone grooves each possess triangular walls, which confer a ball-gripping capability to the golf club face.

### RELATED APPLICATIONS

This application claims the benefit of Provisional Application 61/056,041.

### FIELD OF THE INVENTION

This invention relates to golf club putter design and construction, specifically to creating a precision-ground hitting surface for the putter face.

### BACKGROUND OF THE INVENTION

Golf putter design that focuses on the hitting surface of the putter is an established art. There are several patents in the art which cover the feature of precision grinding, including U.S. Pat. Nos. 4,693,478, 5,688,186, and 7,166,039. None of these patents disclose a surface that is surface ground to a perfectly flat surface combined with a set of precision-ground grooves in the putter's sweet spot.

### SUMMARY OF THE INVENTION

The present invention is a precision grinding system that produces a putter face with no imperfections. This face grinding is substantially better than milling the surface to achieve flatness. Milling leaves many small imperfections in the metal surface that can affect the angle at which a golf ball bounces off of the putter.

The face is first ground smooth and flat, and then an oval pattern of horizontal grooves is ground into the putter's sweet spot. The grooves are triangular and the sides are sloped at an angle of 120 degrees to the surface.

The grooves are set at an even interval across the pattern. The width and depth of the grooves can range between 0.003 and 0.005 inches, each groove the same width and depth as the others.

The grooves convey a gripping quality to the hitting zone that produces a smooth over spin roll when the golf ball is struck. Starting with a precision ground surface, the intervals between the grooves are also smooth-surfaced.

### DESCRIPTION OF THE FIGURES

FIG. 1. Front view of the putter face

FIG. 2. Cross-section of the putter hitting zone

### DETAILED SPECIFICATION

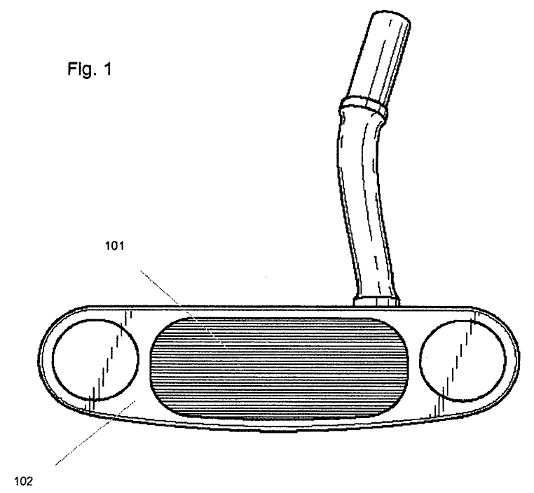

As in FIG. 1, the golf club face is comprised of a hitting surface 102 and a hitting zone 101. The golf club face is first precision ground smooth and flat, and then an pattern of horizontal grooves is ground into the hitting zone 101. The hitting zone 101 is placed symmetrically over the golf club's hitting surface 102 sweet spot. The precision grinding method can be selected from a list including but not limited to lap grinding and surface grinding.

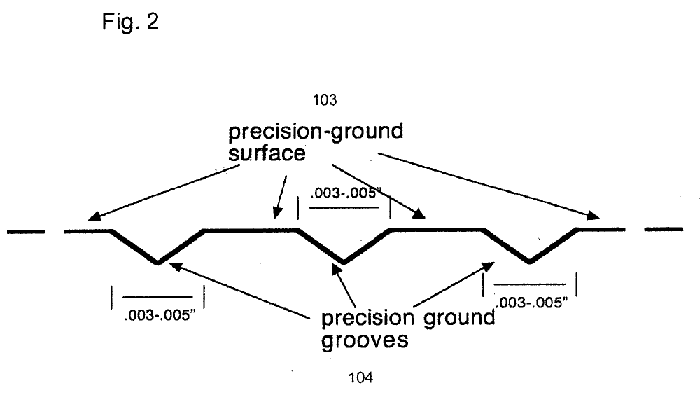

As in FIG. 2, a cross-section view of the hitting zone 101, the plurality of grooves in the hitting zone are triangular and the sides are sloped at an angle of 120 degrees to the surface. The precision ground surface 103 is maintained as in the first grinding.

The grooves are set at an even interval across the pattern of the hitting zone 101. The width and depth of the grooves 104 can range between 0.003 and 0.005 inches, each groove 104 the same width and depth as the others, and set at an equal interval from every other groove 104.

The grooves 104 convey a gripping quality to the hitting zone that produces a smooth over spin roll when the golf ball is struck. Starting with a precision ground surface 102, the intervals between the grooves 104 are also smooth-surfaced.

Although the invention has been described and a preferred embodiment has been provided, equivalent features may be employed and substitutions made within this specification without departing from the scope of the invention as recited in the claims.

What is claimed is:

1. an improved golf club face, the golf club face comprised of a hitting surface and a hitting zone,
the hitting surface produced by a precision grinding means, the hitting surface possessing in a central position a hitting zone, the hitting zone located over the golf club face's sweet spot,
the hitting zone a region of the hitting surface possessing a plurality of diagonally-cut grooves, the diagonally-cut grooves placed in parallel with each other within the hitting zone,
The walls of the diagonally-cut grooves each making an angle of 120 degrees with the hitting surface, the diagonally cut grooves placed in the hitting surface by a precision grinding means.

2. An improved golf club face as in claim 1, where the precision grinding means is selected from the group of lap grinding and surface grinding.

3. A method of producing an improved golf club face as in claim 1, comprised of the steps of
grinding the hitting surface of the golf club face with a precision grinding means to perfect flatness within a stated tolerance,
designating an area over the golf club face's sweet spot as the hitting zone,
grinding parallel grooves with triangular sides into the hitting zone.
